(19) United States
(12) Patent Application Publication
(10) Pub. No.: US 2011/0119509 A1
(43) Pub. Date: May 19, 2011

(54) STORAGE SYSTEM HAVING POWER SAVING FUNCTION

(75) Inventors: Akifumi YANAGAWA, Yokohama (JP); Takeshi Horiuchi, Yokohama (JP); Naoto Yanagi, Kamakura (JP)

(73) Assignee: Hitachi, Ltd.

(21) Appl. No.: 12/696,212

(22) Filed: Jan. 29, 2010

(30) Foreign Application Priority Data
Nov. 16, 2009 (JP) 2009-260616

(51) Int. Cl. G06F 1/32; G06F 12/00; G06F 12/16

(52) U.S. Cl. 713/320; 711/162; 711/E12.001; 711/E12.103

(57) ABSTRACT

A controller of a storage system associates a portion of the logical area of logical storage devices with one or more pool area of a pool. The frequency of I/O (Input/Output) of any of the portion of the logical areas is higher than the I/O frequency of the remaining logical areas of the logical storage devices. In the event of I/O, if a first physical storage device group which forms the basis of the physical storage devices is in a power saving state, then the controller performs I/O of a data element to/from the pool area corresponding to the logical area of the I/O destination, without canceling the power saving state of the first physical storage device group.

### CROSS-REFERENCE TO PRIOR APPLICATION

This application relates to and claims priority from Japanese Patent Application No. 2009-260616, filed on Nov. 16, 2009, the entire disclosure of which is incorporated herein by reference.

### BACKGROUND

The present invention generally relates to power saving in a storage system.

The technology disclosed in Japanese Patent Application Laid-open No. 2000-293314 and Japanese Patent Application Laid-open No. 2008-293149, for example, is known as technology relating to power saving in a storage system.

Japanese Patent Application Laid-open No. 2000-293314 discloses a storage system having a plurality of magnetic disk devices. This storage system spins down magnetic disks in a magnetic disk device which does not have access in a uniform time period, of the plurality of magnetic disk devices.

Japanese Patent Application Laid-open No. 2008-293149 discloses a hierarchical storage system in the field of NAS (Network Attached Storage). A hierarchical storage system comprises a first layer storage apparatus which is coupled to a file server, and a second layer storage apparatus which is coupled to the first layer storage apparatus. The second layer storage apparatus comprises a hard disk and a second volume based on the hard disk. The first layer storage apparatus comprises a hard disk, a first volume based on the hard disk and a volume (virtual volume) which virtualizes the second volume. The file server mounts the virtual volume as a second directory, mounts the first volume as a first directory, and copies files in the second directory to the first directory. By this means, it is possible to acquire a file in the second directory (a file in the second layer storage apparatus) from the first layer storage apparatus, without accessing the second layer storage apparatus. Of the hard disks belonging to the second layer storage apparatus, the power supply to those hard disks storing files which are not accessed is switched off.

### SUMMARY

According to Japanese Patent Application Laid-open No. 2000-293314, it is necessary to spin up magnetic disk devices whenever access is made from a higher-level apparatus. Therefore, if access is made frequently from a higher-level apparatus, then the magnetic disk devices are spun up frequently and sufficient power saving effects cannot be obtained.

According to Japanese Patent Application Laid-open No. 2008-293149, even if there is frequent access from a file server, depending on the file to be accessed, it is not necessary to access the second layer storage apparatus, and therefore it is possible to avoid the occurrence of spin up each time access is performed. However, it is difficult to apply the technology in Japanese Patent Application Laid-open No. 2008-293149 to a storage system other than a NAS system.

The problems described above may also occur in cases where the storage system has physical storage devices other than magnetic disk devices.

Therefore, it is an object of the present invention to reduce the frequency with which a power saving state of physical storage devices is cancelled, not only in a storage system in the NAS field, but also in a storage system other than a NAS system.

The controller of a storage system associates the logical areas of a portion of logical storage devices with one or more pool area of a pool. The frequency of I/O (Input/Output) in the portion of logical areas is higher than the I/O frequency of the remaining logical areas of the logical storage devices. In the event of I/O, if the pool includes a pool area corresponding to the logical area of the I/O destination, then even if the first physical storage device group forming the basis of the logical storage devices is in a power saving state, the controller performs I/O of a data element to/from the pool area corresponding to the I/O destination logical area, without canceling the power saving state. More specifically, since a data element which is the same as the data element stored in the logical area are also stored in a pool area that is associated with that logical area, then if the I/O operation is a read operation, the controller reads the data element which is the same as the data element stored in the read source logical area, from the pool area which is associated with the read source logical area. On the other hand, if the I/O operation is a write operation, then the controller stores the data element forming the write object, in a pool area associated with the write destination logical area.

The storage system comprises a plurality of physical storage device groups which include a first and a second physical storage device group. The respective physical storage device groups are formed by one or more physical storage devices. The physical storage devices may be storage devices of any type (typically, non-volatile storage devices), such as HDDs (Hard Disk Drive), SSDs (Solid State Drives), and the like. The second physical storage device group is a physical storage device group forming the basis of the pool, and desirably, the second physical storage devices which make up the second physical storage device group are physical storage devices which store a data element group of a prescribed size with lower power consumption than the first physical storage devices. More specifically, for example, the first physical storage devices are HDDs and the second physical storage devices are SSDs.

The physical storage device group may be a RAID group formed by a plurality of physical storage devices, or a storage apparatus (for example, a disk array apparatus) having a plurality of physical storage devices, or it may be an independent physical storage device. Furthermore, the controller may be a control apparatus mounted on a storage apparatus, or a higher-level apparatus which sends I/O commands to a storage apparatus, or a higher-level storage apparatus which is coupled to a lower-level storage apparatus (for example, a storage apparatus coupled to a higher-level apparatus (namely, a top-level storage apparatus)).

Furthermore, the “pool area corresponding to the logical areas” may be associated with logical areas either directly or indirectly. An example of direct association is associating a pool area with a logical area. An example of indirect association is associating both a logical area and a pool area with one virtual area of a plurality of virtual areas (virtual storage areas) belonging to a virtual storage device (a virtual logical storage device). In this case, an I/O destination virtual area can be identified and it can be judged whether or not a pool area is associated with that I/O destination virtual area. Associating a pool area with a virtual area means associating a pool area with a logical area via a virtual area. The virtual storage device may be a device having the same capacity as the capacity of the logical storage device, or a device having a different capacity to the capacity of the logical storage device (for example, a virtual logical volume based on thin-provisioning technology).

According to the present invention, it is possible to reduce the frequency with which a power saving state of physical storage devices is cancelled, not only in a storage system in the NAS field, but also in a storage system other than a NAS system.

### BRIEF DESCRIPTION OF THE DRAWINGS

FIG. 1 shows a computer system having a disk array apparatus which employs the storage system relating to a first embodiment of the present invention;

FIG. 2 shows information and computer programs stored in the shared memory 004;

FIG. 3 shows the relationship between storage devices provided by the disk array apparatus 010;

FIG. 4 shows the composition of the RAID group configuration information;

FIG. 5 shows the composition of the LU (pool) configuration information 014;

FIG. 6 shows the composition of the I/O monitoring information 015;

FIG. 7 shows the composition of withdrawal relationship information 016;

FIG. 8 is a flowchart of an I/O command process;

FIG. 9 is a flowchart of spin down processing;

FIG. 10 is a flowchart of spin up processing;

FIG. 11 is a flowchart of I/O processing carried out when the PDEVs of the I/O destination RAID group are in a power saving state;

FIG. 12 shows an I/O range specification screen 041 and an I/O range information screen 046;

FIG. 13 shows a spin down instruction screen 048;

FIG. 14 shows the states of the respective PDEVs in the different phases;

FIG. 15 shows the differences between the length of the transitional phase, when the pool-LDEVs are HDDs and when the pool-LDEVs are SSDs;

FIG. 16 shows a computer system to which the storage system relating to the second embodiment of the present invention is applied;

FIG. 17 shows withdrawal of data elements and I/O of data elements, in a second embodiment of the present invention;

FIG. 18 shows a computer system having a disk array apparatus group which employs the storage system relating to a third embodiment of the present invention;

FIG. 19 shows withdrawal of data elements and I/O of data elements, in a third embodiment of the present invention; and

FIG. 20 is a flowchart of spin down object specification processing relating to a fourth embodiment of the present invention.

### DETAILED DESCRIPTION OF THE EMBODIMENT

Below, several embodiments of the present invention will be described with reference to the drawings. In the following description, the processing performed by a program is actually carried out by a control unit (typically a CPU (Central Processing Unit)) which executes that program.

### First Embodiment

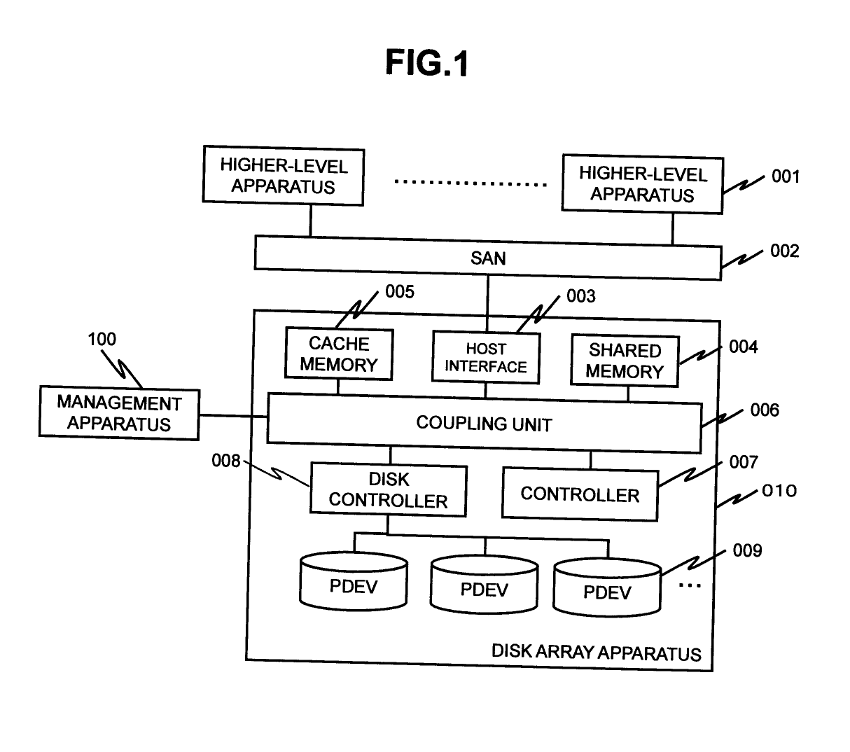

FIG. 1 shows a computer system having a disk array apparatus which employs the storage system relating to a first embodiment of the present invention.

Higher-level apparatuses 001 and a disk array apparatus 010 are coupled to a SAN (Storage Area Network) 002.

A higher-level apparatus 001 is an apparatus which is external to the disk array apparatus 010, for example, a host computer, or a separate disk array apparatus from the disk array apparatus 010. A higher-level apparatus 001 reads and writes data from and to the disk array apparatus 010 by sending an I/O command (write command or read command) to the disk array apparatus 010.

The disk array apparatus 010 comprises a control apparatus which receives I/O commands from a higher-level apparatus, and a plurality of physical storage devices (PDEVs (Physical DEVices)) 009 which are coupled to the control apparatus.

As described hereinafter, a plurality of RAID groups are formed by the plurality of PDEVs 009. Data is stored in the RAID groups in accordance with RAID technology. As described hereinafter, the plurality of RAID groups includes RAID groups constituted by HDDs and RAID groups constituted by SSDs. In general, a SSD is able to store data of a prescribed size with lower power consumption than an HDD.

The control apparatus performs data I/O to and from a PDEV 009 in response to an I/O command from a higher-level apparatus. The control apparatus comprises a host I/F 003, a shared memory 004, a cache memory 005, a disk controller 008, a coupling unit 006 and a controller 007.

The host I/F 003 is an interface device to the higher-level apparatus 001. The host I/F 003 receives an I/O command from the higher-level apparatus 001.

The shared memory 004 stores information which is referenced from the controller 007 and a computer program which is executed by the controller 007.

The cache memory 005 temporarily stores data which is exchanged between the PDEVs 009 and the higher-level apparatus 001.

The disk controller 008 is an interface device to the PDEVs 009. The disk controller 008 writes data to a PDEV 009 and reads data from a PDEV 009.

The controller 007 processes I/O commands received by the host I/F 003 and controls the state of power consumption of the HDDs.

The cache memory 005, the host I/F 003, the shared memory 004, the disk controller 008 and the controller 007 are coupled to the coupling unit 006. The coupling unit 006 is a switch, for example, which couples together the devices that are coupled to the coupling unit 006, in a communicable fashion.

A management apparatus 100 is coupled to the disk array apparatus 010. The management apparatus 100 is a computer, for example. The user is able to set desired information in the disk array apparatus 010 using the management apparatus 100. This information is set in the shared memory 004, for example.

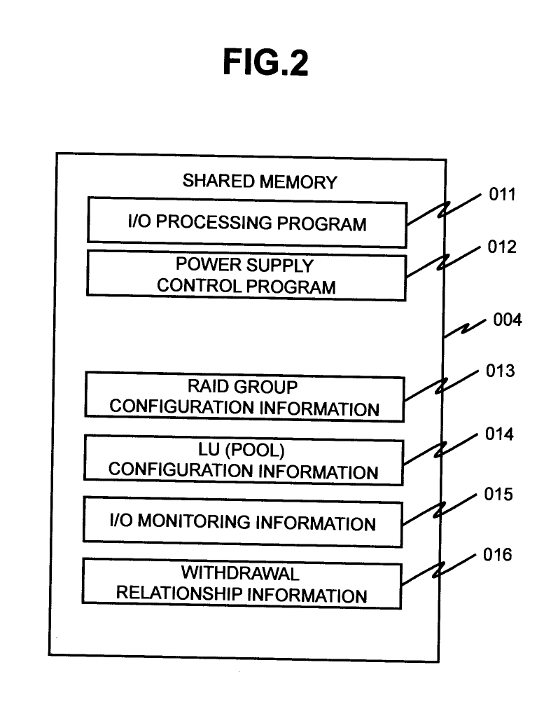

FIG. 2 shows information and computer programs stored in the shared memory 004.

The computer programs stored by the shared memory 004 include an I/O processing program 011 which is a program for processing I/O commands, and a power supply control program 012 which is a program for controlling the power consumption state of the HDDs. The information stored by the shared memory 004 is RAID group configuration information 013, which is information relating to the configuration of the RAID group, LU (pool) configuration information 014 which is information relating to the configuration of the LU (Logical Units) and the pool, I/O monitoring information 015 which is information representing the I/O monitoring results, and withdrawal relationship information 016 which is information relating to the correspondences between the logical areas of LUs (withdrawal source areas) and the pool areas (withdrawal destination areas) of a pool.

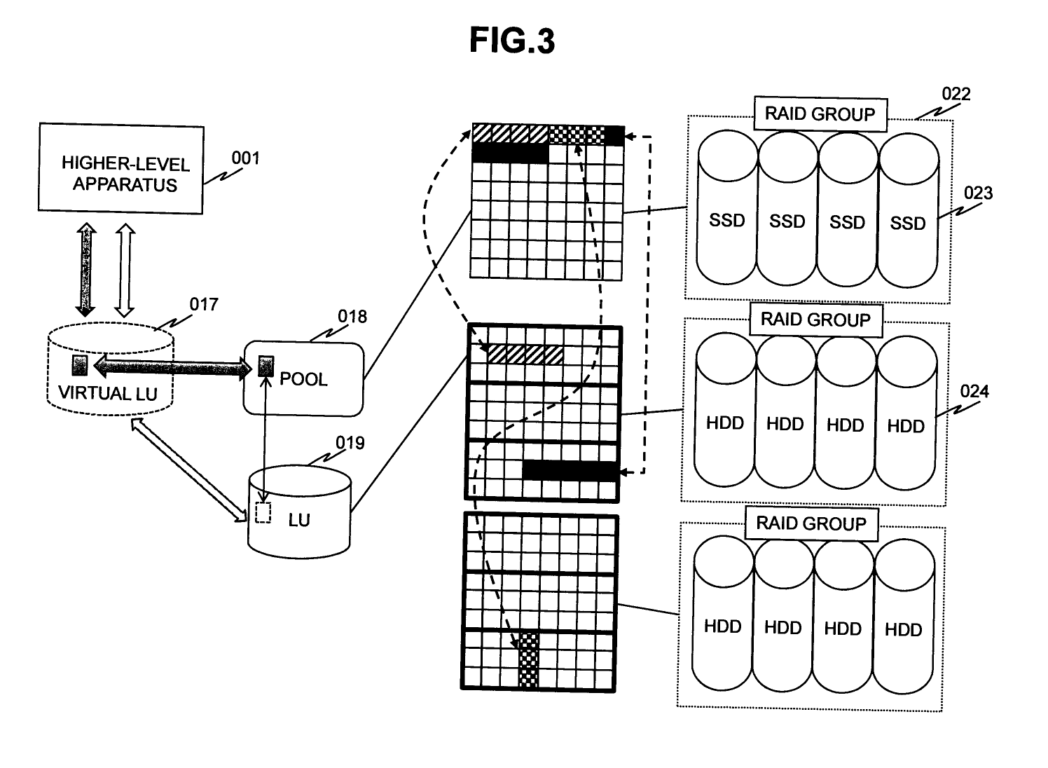

FIG. 3 shows the relationship between storage devices provided by the disk array apparatus 010.

The storage devices are a virtual LU 017, an LU 019, a pool 018, HDDs 024 and SSDs 023.

The virtual LU 017 is a virtual LU which is recognized by the higher-level apparatus 001, and is formed by a plurality of virtual areas (virtual storage areas (blocks)), which are not illustrated. The higher-level apparatus 001 sends an I/O command including information indicating an I/O destination (hereinafter, called I/O destination information), to the disk array apparatus 010, and this I/O destination information includes, for example, an ID of the virtual LU 017 (for example, a LUN (Logical Unit Number)), and an address of a virtual area (for example, an LBA (Logical Block Address)). In other words, the I/O command may be a block-level I/O command. The LU 019 and the pool 018 are associated with the virtual LU 017, and writing of data requests to a virtual area involves either writing to any one of the plurality of logical areas (logical storage areas) 021 which make up the LU 019 or writing to any one of the plurality of pool areas (logical storages areas) 020 which make up the pool 018. Consequently, the plurality of data elements which are recognized from the higher-level apparatus 001 when stored in the virtual LU 017 may be a group of data elements which are stored in the LU 019 and data elements which are stored in the pool 018. A “data element” referred to in the present embodiment means data which is stored in a virtual area, logical area and pool area. Furthermore, a plurality of LUs 019 and/or a plurality of pools 018 are associated with one virtual LU 017. Furthermore, according to the example in FIG. 3, the LUs 019 and the pool 018 correspond in a many to one relationship (one pool 018 corresponds to a plurality of LUs 019), but instead of this, a one to one or one to many relationship may be adopted.

The LU 019 is a logical storage device and is a portion or all of the storage space of the RAID group (hereinafter, called HDD group) which is constituted by a plurality of HDDs 024. The LU 019 spans over two or more HDDs 024 which make up the HDD group. A PDEV other than an HDD, for example, an SSD, can be used as the PDEV forming the basis of an LU 019.

The pool 018 is a logical storage device similar to the LU 019 (for example, one type of LU), and is a portion or all of the storage area of the RAID group (hereinafter, SSD group) which is made up of a plurality of SSDs 023. The pool 018 spans over two or more of the SSDs 023 which make up the SSD group. A PDEV other than an SSD, for example, an HDD, can be used as the PDEV forming the basis of a pool 018. However, desirably, the PDEV forming the basis of the pool 018 is a PDEV having lower power consumption than the PDEV forming the basis of the LU 019 (and more specifically, a PDEV which can save data of the same size with smaller power consumption).

The HDDs 024 and the SSDs 023 are one type of PDEV. The HDDs 024 may be set to a power saving state during the operation of the disk array apparatus 010. A power saving state of an HDD 024 is a state where the disk speed is set to a low speed or zero. When the power saving state of an HDD 024 is canceled (in other words, if spin up of the disk of the HDD 024 is started), then eventually the HDD 024 assumes a non-power saving state (operating state). The non-power saving state of an HDD 024 means that the speed of rotation of the disk is a high speed which is sufficient to enable I/O. The power saving state and non-power saving state of the HDDs 024 are switched in units of one HDD group. An HDD group unit is, for example, a RAID group unit. If the PDEVs forming the basis of the LUs 019 are PDEVs other than HDDs, then a power saving state is a power off state and a non-power saving state is a power on state.

The logical area 021 of a portion of the LUs 019 corresponds to one or more pool area 020 of the pool 018. More specifically, for example, as shown in FIG. 3, the data elements in the logical area 021 of a portion of the LUs 019 are copied to one or more pool 020.

The I/O processing program 011 (see FIG. 2) carries out the processing in (C1) to (C6) described below when an I/O command relating to a virtual area of the virtual LU 017 is received.

(C1) The program judges whether or not the LUs 019 associated with the virtual LU 017 are in a power saving state (more specifically, if the HDD group forming the basis of the LUs 019 is in a power saving state).

(C2) If the judgment result of (C1) above is negative, I/O of data element is carried out to/from the logical area (the logical area in the LU 019) which corresponds to the virtual area (I/O destination virtual area) identified from the I/O destination information of the I/O command.

(C3) If the judgment result of (C1) above is affirmative, then it is judged whether or not there is a pool area associated with the logical area corresponding to the virtual area of the I/O destination.

(C4) If the judgment result in (C3) above is negative, then the power saving state of the HDD group (the respective HDDs 024) forming the basis of the LUs 019 is canceled, and I/O of data element is performed to/from the logical area corresponding to the virtual area of the I/O destination.

(C5) If the judgment result in (C3) above is affirmative, then I/O of data element is performed to/from the pool area corresponding to the logical area of the I/O destination, without canceling the power saving state of the HDD group forming the basis of the LUs 019.

(C6) After (C4) described above, the HDD group forming the basis of the LUO is set to a power saving state.

The I/O processing program 011 calls up the power supply control program 012 in order to set the respective HDDs which make up the HDD group (RAID group) to a power saving state, or in order to cancel this power saving state. The power supply control program 012 thus called sets the respective HDDs which make up the HDD group to a power saving state or cancels this power saving state.

The I/O processing program 011 may execute (C6) above immediately after (C3) above, (may execute (C6) each time (C3) is executed), or may execute (C6) above once when (C3) above has been executed N times (where N is an integer or two or more), or may execute (C6) above when no I/O relating to the HDD group has occurred after a prescribed period of time has passed after the last occurrence of an I/O to the HDD group.

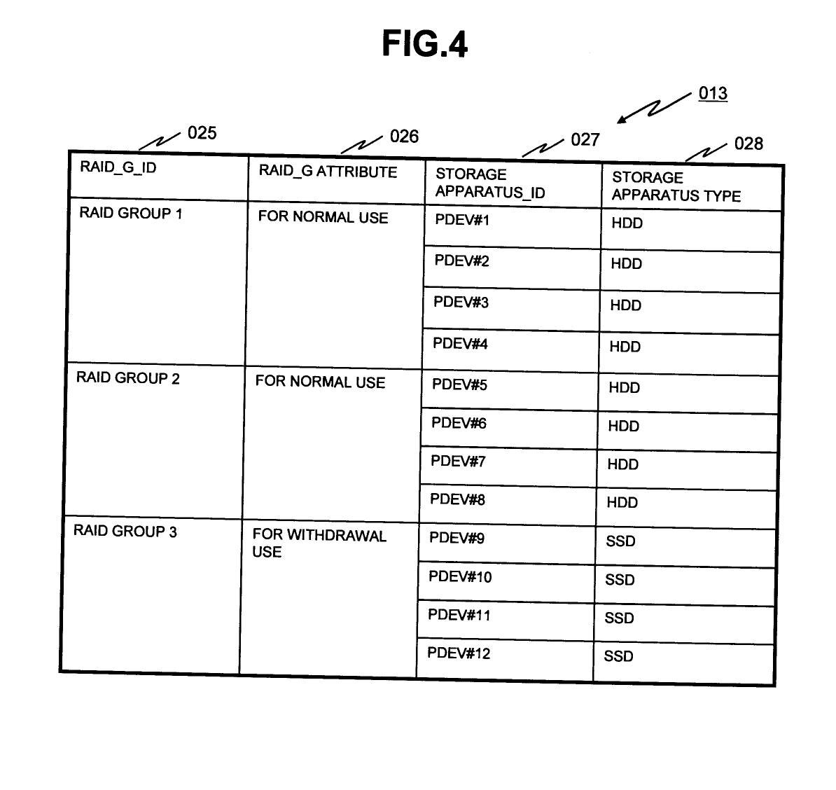

FIG. 4 shows the composition of the RAID group configuration information 013.

The RAID group configuration information 013 comprises, for each RAID group, a RAID_G_ID 025, RAID_G attribute 026, PDEV_ID 027, and PDEV type 028.

The RAID_G_ID 025 is the ID of the RAID group.

The RAID_G attribute 026 is information indicating the attribute of the RAID group, for instance, whether the group is for normal use or for withdrawal use. “Normal use” means that the RAID group provides an LU 019. “Withdrawal use” means that the RAID group provides a pool 018.

The PDEV_ID 027 states the IDs of the PDEVs which make up the RAID group.

The PDEV type 028 is information indicating the type of the PDEVs which make up the RAID group.

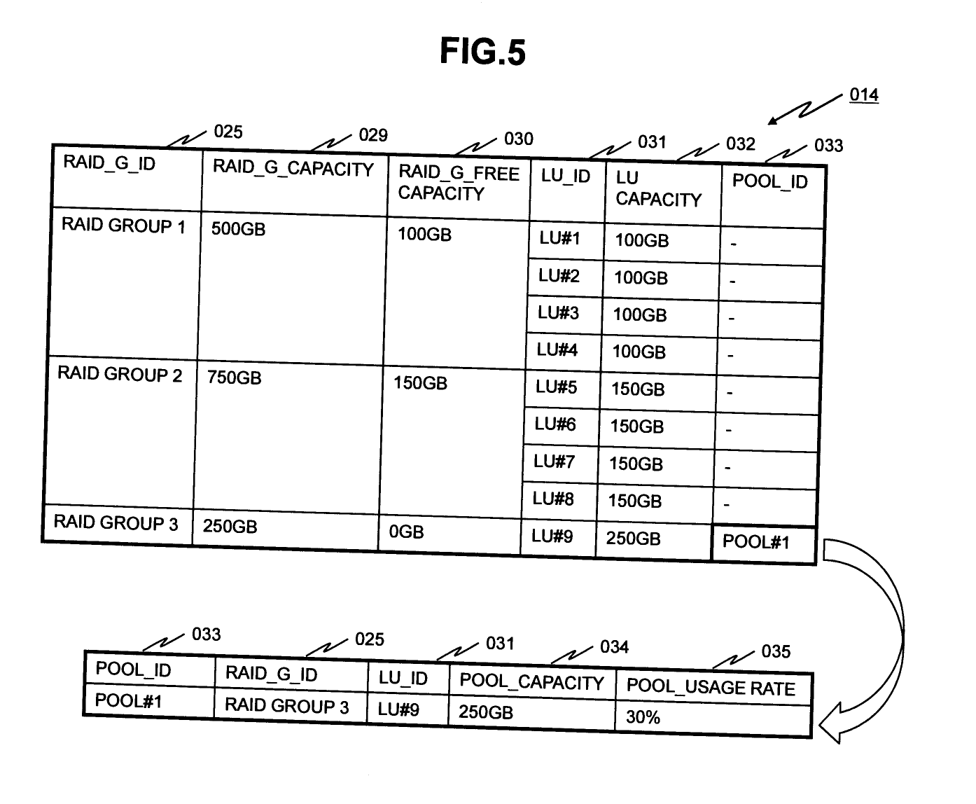

FIG. 5 shows the composition of the LU (pool) configuration information 014.

The LU (pool) configuration information 014 includes, for each logical storage device, a RAID_G_ID 025, RAID_G_capacity 029, RAID_G_free capacity 030, LU_ID 031, LU capacity 032, and POOL_ID 033.

The RAID_G_ID 025 is the ID of the RAID group which forms the basis of the logical storage device.

The RAID_G_capacity 029 is information which represents the capacity of the RAID group forming the basis of the logical storage device.

The RAID_G_free capacity 030 is information which represents the capacity, of the capacity of the RAID group forming the basis of the logical storage device, which is not used as the logical storage device.

The LU_ID 031 is the ID of the logical storage device (LU).

The LU capacity 032 is the capacity of the logical storage device (LU).

The POOL_ID 033 is an ID applied when the logical storage device is a pool, in other words, the pool ID.

If the logical storage device is a pool, the LU (pool) configuration information 014 comprises a POOL_ID 033, RAID_G_ID 025, LU_ID 031, POOL_capacity 034, and POOL_usage rate 035. The POOL_ID 033, RAID_G_ID 025 and LU_ID 031 are as stated previously. The reason that there is an LU_ID 031 for the pool is because the pool is one type of LU. The POOL_capacity 034 is the capacity of the pool and this value is the same value as the LU capacity 032 relating to the logical storage device which is the pool. The POOL_usage rate 035 is the ratio of the total capacity of the pool area which is storing data element in the pool, to the capacity of the pool.

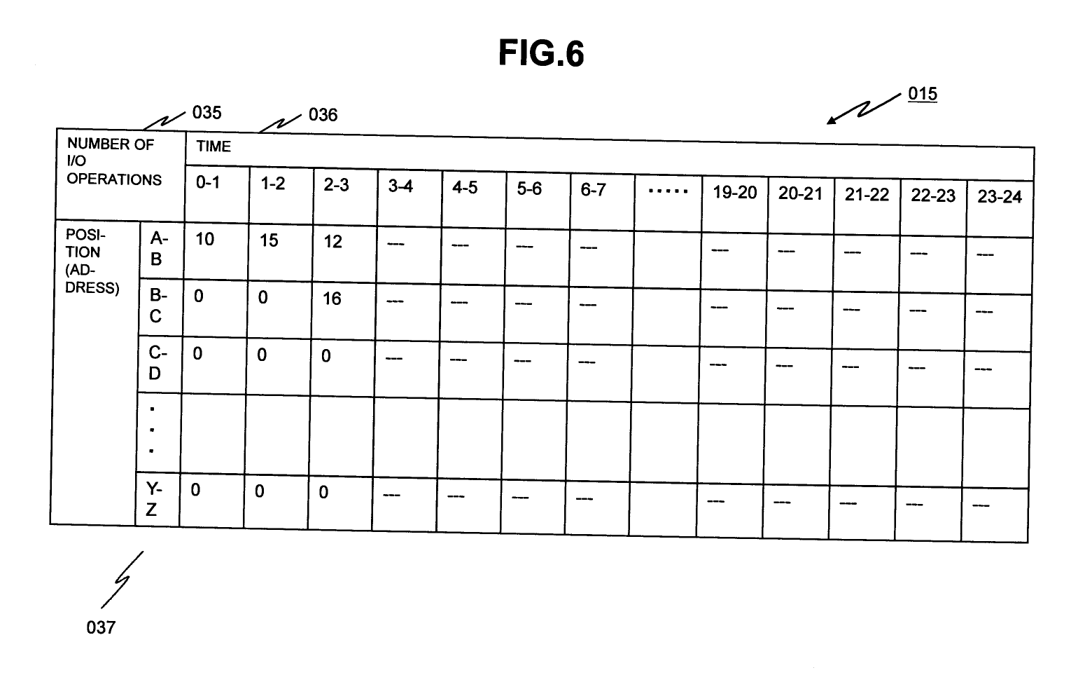

FIG. 6 shows the composition of the I/O monitoring information 015.

The I/O monitoring information 015 is information which is prepared for each RAID group that is the object of I/O monitoring (hereinafter, called monitoring target RAID group). The ID of the monitoring target RAID group is, for example, set previously by a controller, and therefore the I/O processing program 011 is able to identify which of the plurality of RAID groups is the object of monitoring.

The I/O monitoring information 015 is referenced when specifying a logical area forming a withdrawal source. In other words, in the present embodiment, the monitoring target RAID group of a plurality of RAID groups is a RAID group which can be set to a power saving state.

The I/O monitoring information 015 has information representing the frequency of I/O, for each logical area (for example, each block). For instance, the I/O monitoring information 015 has information representing the number of I/O operations in each time band, for each logical area (for example, each block). More specifically, for instance, the I/O monitoring information 015 includes a time 036, position (address) 037 and number of I/O operations 061.

The time 036 represents a respective time band. In the example shown in FIG. 6, the number of I/O operations in each hour of a 24-hour period is recorded, but the time band may be set to any time length. Furthermore, it is not necessary for all of the plurality of time bands to be of the same length. Moreover, it is not necessary for the total of the plurality of time bands to be 24 hours.

The position (address) 037 represents the address (for example, physical address) in the RAID group which corresponds to the address (for example, logical address) of the logical area.

The number of I/O operations 061 represents the number of I/O operations (the total of write and read operations). It is also possible to prepare the number of write operations and/or number of read operations, instead of or in addition to the number of I/O operations.

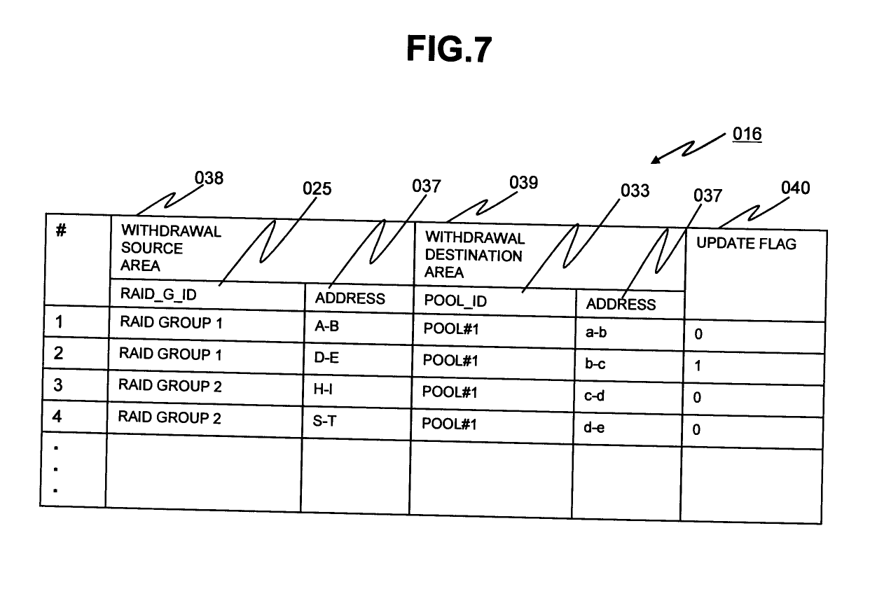

FIG. 7 shows the composition of withdrawal relationship information 016.

The withdrawal relationship information 016 includes a withdrawal source area 038, a withdrawal destination area 039 and an update flag 040, for each correspondence between a withdrawal source area and a withdrawal destination area.

The withdrawal source area 038 is information representing the logical area based on the RAID group. This is because the data element stored in the logical area in the LU 019 based on the RAID group are withdrawn to the pool area of the pool 018. The withdrawal source area 038 comprises, for example, a RAID_G_ID 025 and an address 037. The RAID_G_ID 025 is the ID of the RAID group forming the basis of the logical area which is the withdrawal source. The address 037 is the address of the withdrawal source logical area in the RAID group.

The withdrawal destination area 039 is information representing the pool area. The withdrawal destination area 039 includes, for example, the POOL_ID 033 and the address 037. The POOL_ID 033 is the ID of the pool which includes the withdrawal destination pool area. The address 037 is the address within the RAID group of the withdrawal destination pool area.

The update flag 040 is information indicating whether or not an update has occurred in the withdrawal destination pool area. A value of “1” means that an update has occurred, in other words, that the data element in the pool area of the withdrawal destination is different to the data element in the logical area of the withdrawal source. A value of “0” means that an update has not occurred, in other words, that the data element in the pool area of the withdrawal destination is the same as the data element in the logical area of the withdrawal source. For example, if a data element in the pool area of the withdrawal destination is overwritten after the data element has been withdrawn (copied) from the logical area of the withdrawal source to the pool area of the withdrawal destination, then an update flag 040 corresponding to that withdrawal source pool area is updated from “0” to “1”.

The address 037 in the I/O monitoring information 015 and the withdrawal relationship information 016 represents a physical address (address in a RAID group) of a logical area or pool area, but instead of or in addition to this, it is also possible to combine an LU or pool ID with a logical address.

Below, a processing sequence carried out in the present embodiment will be described.

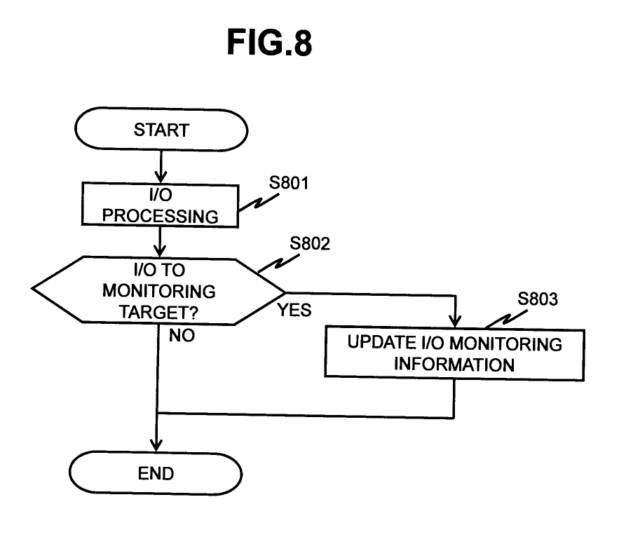

FIG. 8 is a flowchart of an I/O command process.

The I/O processing program 011 executes I/O processing of any of a plurality of types, upon receiving an I/O command from the higher-level apparatus 001 (S801). More specifically, for example, the program 011 carries out the following processing:

(S801-1) Identify the virtual LU 017 and the virtual area of the I/O destination, from the I/O destination information included in the I/O command;

(S801-2) Judge whether or not the I/O object data element relating to the identified virtual area is present in the cache memory 005;

(S801-3) If the I/O command is a read command and the judgment result in S801-2 is affirmative, then read out the data element that is the read object from the cache memory 005 and provide to the higher-level apparatus 001;

(S801-4) If the I/O command is a write command and the judgment result in S801-2 is negative, then write the data element that is a write object, to the cache memory 005, and proceed to S801-6;

(S801-5) If the judgment result of S801-2 is affirmative, proceed to S801-6;

(S801-6) Identify the LU 019 associated with the virtual LU 017 identified in S801-1 (for example, identify the LU 019 by referring to information expressing the association between the virtual LU 017 and the LU 019 (for example, information (not illustrated) which is stored in the shared memory 004)).

(S801-7) Refer to the RAID group configuration information 013 and identify RAID group providing the identified LU 019;

(S801-8) Judge whether or not the respective PDEVs of the identified RAID group are in a power saving state;

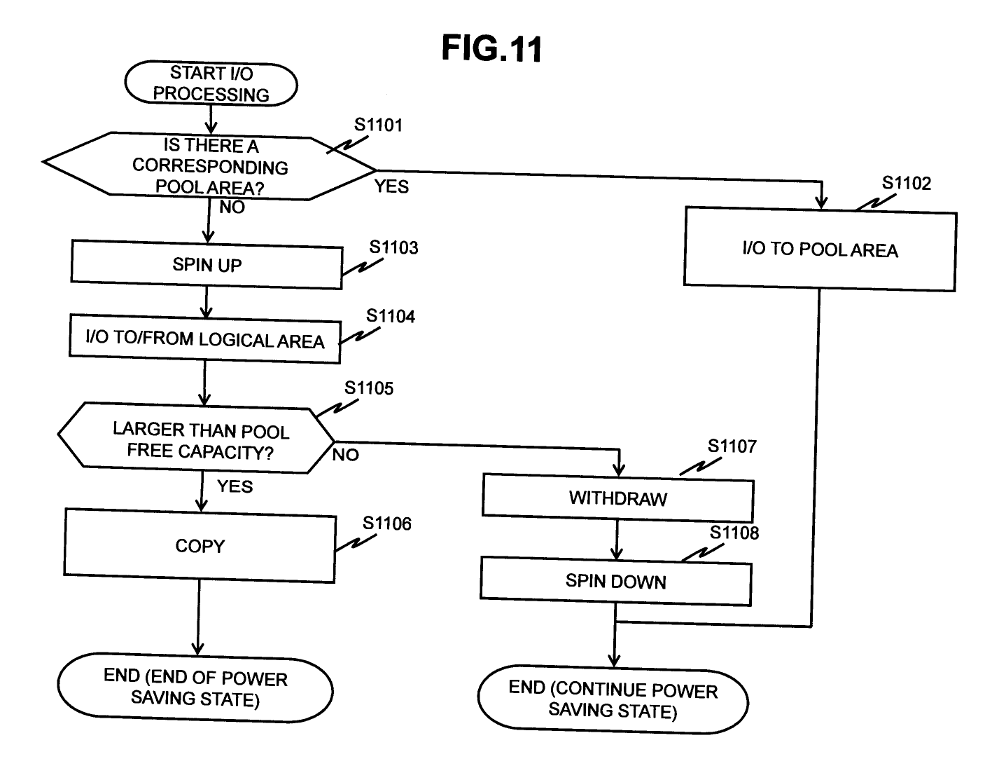

(S801-9) If the judgment result of S801-8 is affirmative, execute the I/O processing in FIG. 11;

(S801-10) If the judgment result in S801-8 is negative, execute normal I/O processing, in other words, I/O to/from the logical area corresponding to the virtual area identified in S801-1 (the logical area in the LU 019 identified in S801-6).

After the I/O processing in S801, the program 011 judges whether or not the RAID group providing the LU 019, which is the RAID group that formed the I/O destination in the I/O processing in S801, is a monitoring target RAID group (S802).

If the judgment result of S802 is affirmative, then the program 011 updates the I/O monitoring information 015 (S803). More specifically, the program 011 increments the corresponding number of I/O operations in the I/O monitoring information 015 corresponding to the monitoring target RAID group which was the I/O destination in S801. Here, the “corresponding number of I/O operations” is the number of I/O operations corresponding to the time band to which the time relating to the received I/O command belongs. The “time relating to the I/O command” means, for example, the reception time of the I/O command, the time when processing of the I/O command was completed (for example, the time that a completion response was sent back to the higher-level apparatus 001), or the time indicated by a time stamp in the I/O command.

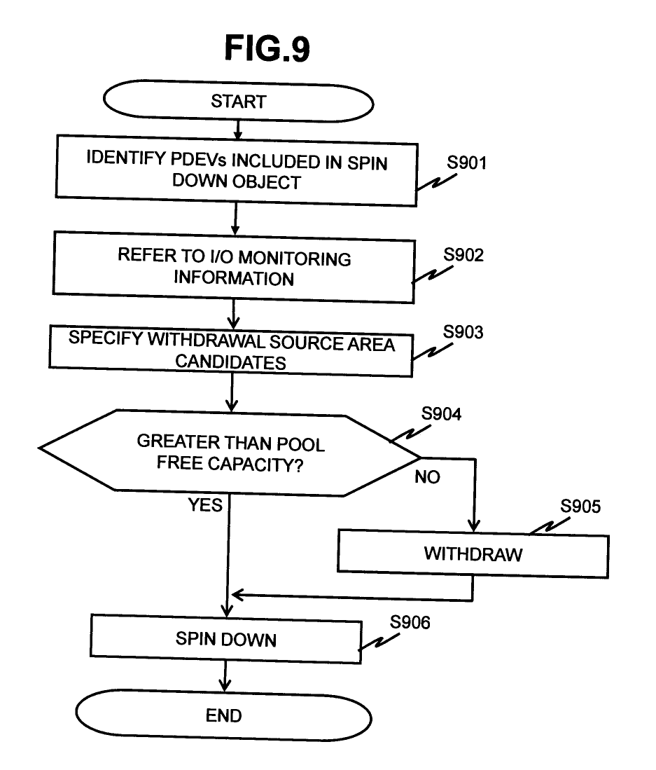

FIG. 9 is a flowchart of spin down processing.

This spin down processing may be started up, for example when a user has input a power saving instruction including a RAID group ID or an LU ID, to the power supply control program 012, or may be started when the current time (for instance, the time as identified from a timer (not illustrated)) has reached a predetermined spin down start time.

The program 012 identifies the PDEVs included in the RAID group that is the spin down object, by referring to the RAID group configuration information 013 (S901). The “RAID group that is the spin down object” may be identified on the basis of the RAID group ID or LU ID included in the power saving instruction (if the instruction includes an LU ID, the RAID group providing that LU may be identified from the LU (pool) configuration information 014), or it may be set in advance.

The program 012 specifies withdrawal source area candidates (S903). A withdrawal source area candidate is a logical area where there is higher I/O frequency than the I/O frequency in a logical area which is not set as a withdrawal source area candidate. More specifically, for example, the withdrawal source area candidate is a logical area having an I/O frequency belonging to the upper X areas or upper Y % (where both X and Y are natural numbers), of the plurality of logical areas which are provided by the RAID group that is the spin down object, or is a logical area having an I/O frequency which exceeds a prescribed threshold value. The time during which the I/O frequency is considered is a time depending on the withdrawal source area specification policy, which is described below.

The program 012 judges whether or not the total capacity of the one or more withdrawal source area candidates specified at S903 is greater than the free capacity of the pool 018 (S904). The free capacity of the pool 018 is calculated on the basis of the POOL_capacity 034 and the POOL_usage rate 035 in the LU (pool) configuration information 014.

If the judgment result of S904 is negative, then the program 012 withdraws (copies) the data element in the respective withdrawal source area candidates specified at S903, to a free pool area (S905). In so doing, the program 012 updates the withdrawal relationship information 016. More specifically, for each pair of a withdrawal source area candidate and a withdrawal destination area candidate, the program 012 adds a withdrawal source area 038 which represents the withdrawal source area candidate and a withdrawal destination source area 039 which represents the withdrawal destination pool area.

Thereupon, the program 012 spins down all of the PDEVs (HDDs) identified in S901. In other words, the program 012 sets all of the PDEVs identified in S901 to a power saving state.

If the judgment result in S904 is affirmative, the program 012 executes S906 without executing S905. According to this example, if the judgment result in S904 is affirmative, the withdrawal of data element from the withdrawal source area candidates specified at S903 to the free pool area is not carried out at all, but instead of this, it is also possible to carry out partial withdrawal of the data elements. More specifically, for example, the program 012 may specify a portion of the withdrawal source area candidates (one or more withdrawal source area candidates) which have a total capacity equal to or less than the free capacity of the pool 018, of the withdrawal source area candidates specified at S903, and may withdraw data elements from the specified withdrawal source area candidates to the free pool area.

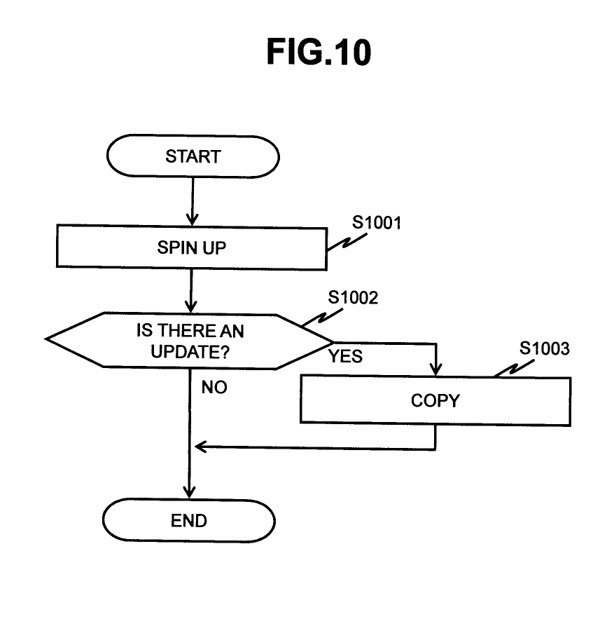

FIG. 10 is a flowchart of spin up processing.

This spin up processing may be started up, for example when a user has input a power saving cancellation instruction including a RAID group ID or an LU ID, to the power supply control program 012, or may be started when the current time has reached a predetermined spin down end time.

The program 012 spins up all of the PDEVs belonging to the RAID group that is the object of spin up processing (S1001). The “RAID group that is the object of spin up” may be identified on the basis of the RAID group ID or LU ID included in the power saving cancellation instruction (if the instruction includes an LU ID, the RAID group providing that LU may be identified from the LU (pool) configuration information 014), or it may be set in advance. Furthermore, the PDEVs belonging to the RAID group that is the object of spin up processing are identified on the basis of the RAID group configuration information 013.

The program 012 judges whether or not a pool area having an update has been associated with at least one of the plurality of logical areas provided by the RAID group that is the object of spin up processing (S1002). More specifically, for example, the program 012 refers to the withdrawal relationship information 016 and judges whether or not the logical area represented by a withdrawal source region 038 corresponding to an update flag 040 having a value of “1” is included in the plurality of logical areas provided by the RAID group that is the object of spin up processing.

If the judgment result in S1002 is affirmative, then the program 012 copies the data element in the pool area having the update, to the logical area corresponding to that pool area (S1003).

FIG. 11 is a flowchart of I/O processing carried out when the respective PDEVs of the RAID group specified on the basis of an I/O command (below, called the I/O destination RAID group) are in a power saving state.

The I/O processing program 011 refers to the withdrawal relationship information 016 and judges, in respect of each of the one or more virtual areas specified on the basis of the I/O command, whether or not a pool area has been associated with the logical area corresponding to the virtual area (in the description in FIG. 11, the logical area is called “I/O destination logical area”) (S1101).

If the judgment result in S1101 is affirmative, then the program 011 performs I/O of data element to/from the pool area associated with the I/O destination logical area (S1102). In S1102, since I/O of data element is carried out to/from the storage area (in other words, the pool area) based on a RAID group which has not been set to a power saving state during operation of the disk array apparatus 010, then cancel of the power saving state of the PDEVs is not carried out. If the I/O operation is a write operation and the update flag 040 corresponding to the pool area of the write destination is “0”, then the program 011 updates the update flag 040 corresponding to this pool area to “1”, at S1102.

If the judgment result in S1101 is negative, the program 011 calls the power supply control program 012 and spins up the PDEVs of the I/O destination RAID group (S1103). In other words, the program 011 cancels the power saving state of these PDEVs. The program 011 then performs I/O of data element to/from the I/O destination logical area (S1104).

Next, the program 011 judges whether or not the total capacity of the one or more I/O destination logical areas in S1104 is greater than the free capacity of the pool 018 (S1105).

If the judgment result of S1105 is affirmative, the program 011 identifies a pool area having an update which is associated with the I/O destination RAID group, and the logical area corresponding to this pool area having an update, on the basis of the withdrawal relationship information 016, and copies the data element to the logical area identified from the specified pool area having an update (S1106). The respective PDEVs of the I/O destination RAID group are left in a state where the power saving state is canceled.

If the judgment result at S1105 is negative, then the program 011 withdraws (copies) the I/O target data element relating to the I/O destination logical area in S1104, to a free pool area (S1107). In so doing, the program 011 updates the withdrawal relationship information 016. More specifically, for example, the program 011 adds a withdrawal source area 038 which represents the I/O destination logical area and a withdrawal destination pool area 039. Thereupon, the program 011 calls the power supply control program 012 and spins down the PDEVs of the I/O destination RAID group (S1108). In other words, the program 011 returns the respective PDEVs of the I/O destination RAID group to a power saving state. The program 011 does not necessarily have to carry out S1108 each time step S1107 is executed. For example, the program 011 may execute S1108 when a prescribed time period has elapsed since S1107 was last executed, without S1107 being executed again.

The RAID group that is the spin down object described above is set, for instance, by carrying out the processing described below.

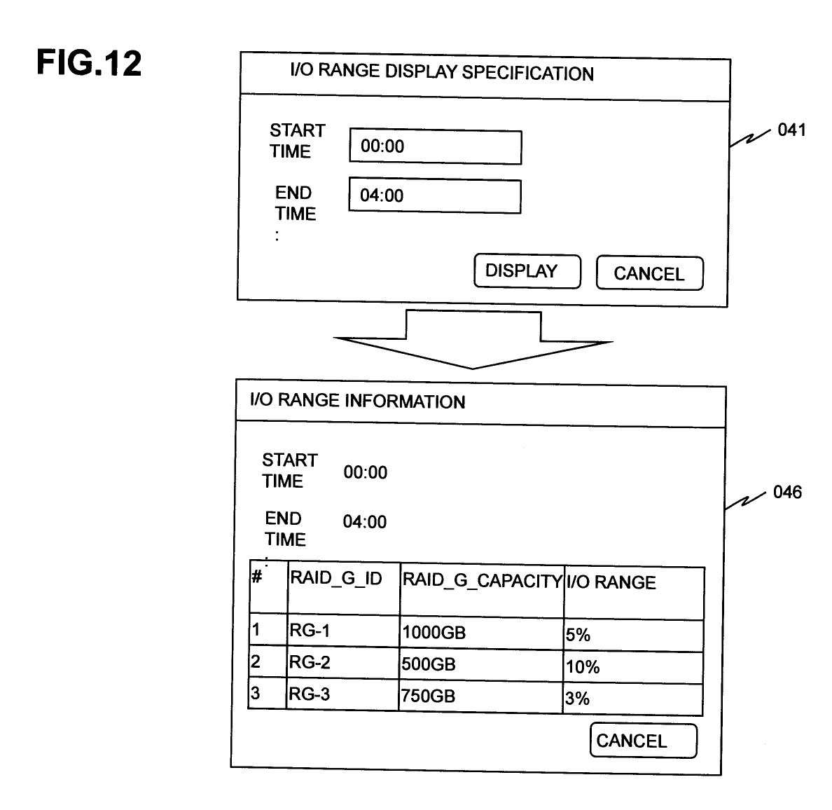

(S01) The management apparatus 100 displays the I/O range specification screen shown in FIG. 12 (for example, a GUI (Graphical User Interface)) 041. The user inputs a start time and end time to this GUI 041.

(S02) The management apparatus 100 acquires I/O monitoring information 015 from the disk array apparatus 010.

(S03) The management apparatus 100 calculates the I/O range for the respective monitoring target RAID groups, on the basis of the start time and end time input at S01, and the I/O monitoring information 015 acquired at S02.

(S04) The management apparatus 100 displays the I/O range information screen 046 shown in FIG. 12, in other words, a screen showing the calculation results from S03. Here, the “I/O range” means the ratio of the total (overall capacity) of the logical areas where I/O has occurred, with respect to the total of the logical areas provided by the monitoring target RAID group (namely, the capacity of the monitoring target RAID group). If an I/O operation has occurred once during the time period between the start time and end time input at S01, then this is counted in respect of the logical area where the I/O operation has occurred.

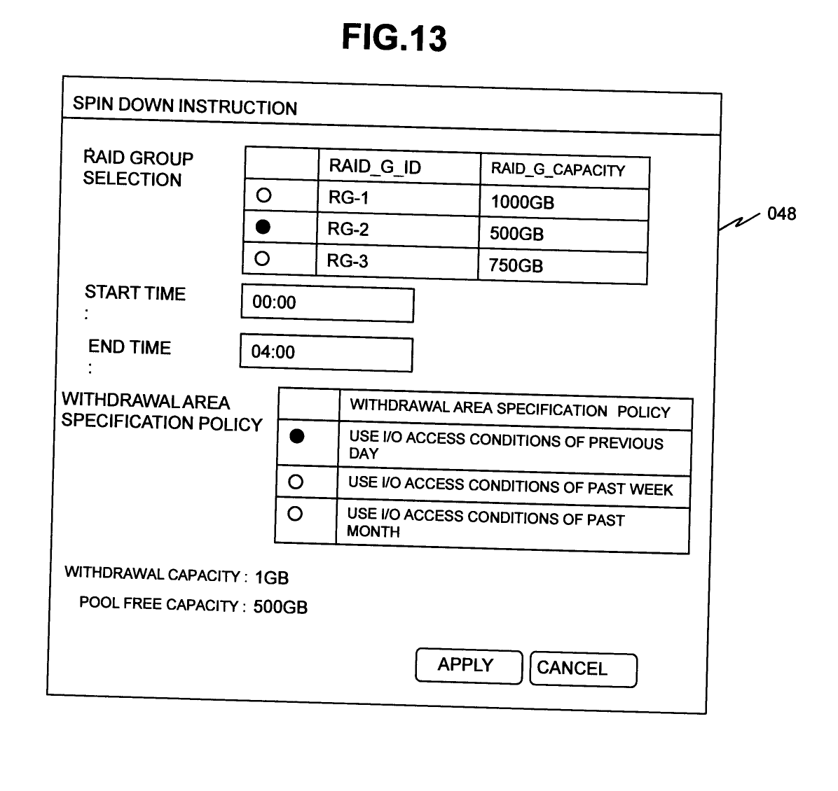

(S05) The management apparatus 100 displays the spin down instruction screen 048 shown in FIG. 13 in response to a request from the user. The user specifies the RAID group that is the spin down object, via the screen 048, on the basis of the I/O range of each monitoring target RAID group, which is displayed at S04. The free pool capacity is shown on the screen 048, and in addition to setting the RAID group that is the spin down object, it is also possible to set at least one of the start time and end time of the power saving state (spin down), the withdrawal source area specification policy, and the withdrawal capacity. The “free pool capacity” means the total capacity of the free pool area. The “start time and end time” may employ the start time and end time input on the I/O range specification screen 041 in FIG. 12, or may be input newly by the user. The “withdrawal source area specification policy” is the time period which is considered in the processing in S903 in FIG. 9 (the specification of the withdrawal source logical area) (range of I/O monitoring information 015). According to the example in FIG. 13, there are three types of withdrawal source area specification policy: previous day, previous week and previous month; and of these three types, the previous day policy has been selected. The “withdrawal capacity” is the total capacity of the logical area of the withdrawal source, of the plurality of logical areas provided by the RAID group selected as a spin down object. The user is able to specify the withdrawal capacity on the basis of the “free pool capacity” displayed.

In steps S01 to S05 above, the I/O range is calculated by the controller 007 or the higher-level apparatus 001, instead of the management apparatus 100. At least one higher-level apparatus 001 may function as a management apparatus 100.

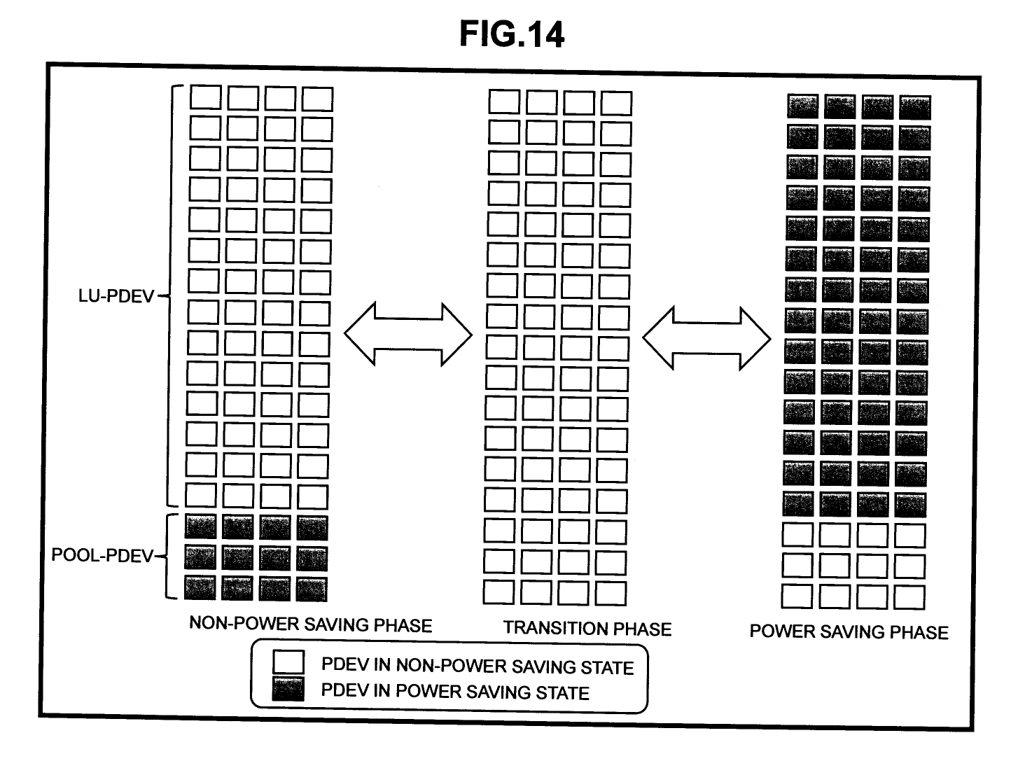

FIG. 14 shows the states of the respective PDEVs in the different phases according to the present embodiment.

In the non-power saving phase (during normal operation (I/O monitoring)), the PDEVs which make up the RAID group providing the LU 019 (hereinafter, called “LU-PDEVs”) are in a non-power saving state, and the PDEVs which make up the RAID group providing the pool 018 (hereinafter, called “pool-PDEVs”) are in a power saving state. Therefore, in a non-power saving phase, I/O to/from the LU 019 is carried out regardless of whether or not the pool 018 includes a pool area corresponding to a logical area within the LU 019. If the pool-PDEVs have superior I/O performance and lower power consumption than the LU-PDEVs, then the pool-PDEVs may be set to a non-power saving state, even in the non-power saving phase. In this case, in the non-power saving phase, if a pool area corresponding to the logical area in the LU 019 is present in the pool 018, then I/O may be carried out to/from the pool area, rather than the logical area.

In the transition phase (in other words, in the transition phase from a non-power saving phase to a power saving phase or in the transition phase from a power saving phase to a non-power saving phase), neither the LU-PDEVs nor the pool-PDEVs are in a power saving state. For example, the LU-PDEVs (and pool-PDEVs) are in the process of spin up or in the process of spin down.

In the power saving phase (for example, between the spin down start time and end time), the pool-PDEVs are in a non-power saving state and the LU-PDEVs are in a power saving state. In this case, as stated above, if there is a pool area corresponding to the logical area, then I/O is carried out to/from the pool area, and if there is no pool area corresponding to the logical area, then the power saving state of the LU-PDEVs of the RAID group providing the logical area is temporarily canceled and I/O is carried out to/from the logical area.

In the example shown in FIG. 14, all of the RAID groups providing one or more LU 019 transfer to the respective phases in unison, but there may be various different phases in each RAID group. The RAID group which provides the pool 018 may be common to the two or more RAID groups which provide the one or more LUs 019.

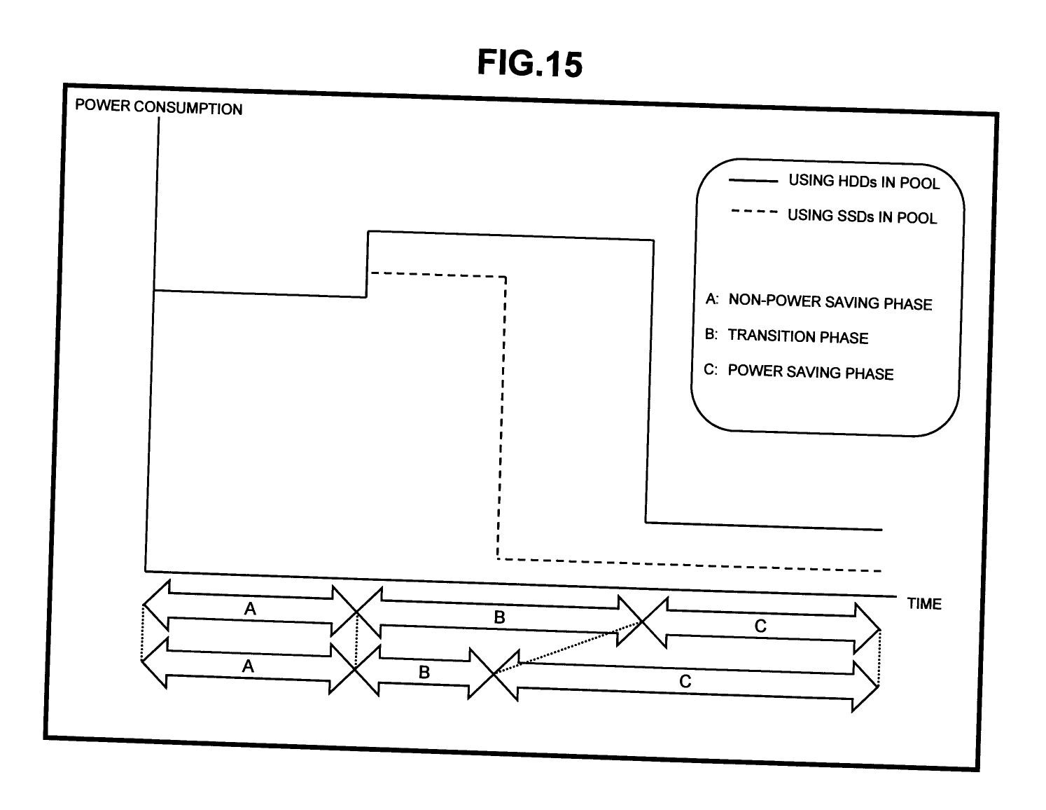

FIG. 15 shows the differences between the length of the transitional phase, when the pool-LDEVs are HDDs and when the pool-LDEVs are SSDs.

If the pool-LDEVs are SSDs, then the transition from the non-power saving phase to the power saving phase is made more quickly than when the pool-LDEVs are HDDs.

For example, the pool-PDEVs may be PDEVs of large capacity, such as SATA (Serial ATA)-HDDs. In this case, a saving in the number of pool-PDEVs can be anticipated.

In this way, since a higher power saving effect can be expected, depending on the type of PDEV, it is possible to specify the appropriate type of pool-PDEV in accordance with the capacity of the pool 018 and the I/O performance required of the pool 018. Alternatively, it is possible to prepare a plurality of pools 018 for each type of pool-PDEV, and to select the withdrawal destination pool 018 for each RAID group that is a spin down object, on the basis of the I/O frequency of the respective time bands and the respective logical areas. The relationship between the RAID group providing the LUs 019 and the pool 018 may be taken as an n:m relationship, (where n and m are natural numbers and at least one of n and m is two or greater).

According to the present embodiment described above, a portion of RAID groups of the plurality of RAID groups which provide the plurality of LUs 019 are taken as RAID groups that are the object of spin down. In each of this portion of RAID groups, the time band in which the I/O range is narrow is taken as the time band of the power saving phase. Furthermore, the logical areas having relatively high I/O frequency, of the plurality of logical areas provided by the RAID groups that are spin down objects, are taken as withdrawal source logical areas. Data element are withdrawn from the withdrawal source logical areas to the pool area, whereupon the PDEVs which make up the RAID groups that are spin down objects are set to a power saving state. When the disk array apparatus 010 subsequently receives a block-level I/O command from a higher-level apparatus 001 and this produces an I/O operation in a logical area, if the PDEVs of the RAID group providing the logical area corresponding to the virtual area of the I/O destination are in a power saving state and there is a pool area corresponding to this logical area (a pool area storing the data element that have been withdrawn from that logical area), then the I/O operation is carried out to/from the pool area, without having to cancel the power saving state of the PDEVs. By this means, it is possible to reduce the frequency with which the power saving state of the PDEVs is canceled in a disk array apparatus which receives a block-level I/O command.

### Second Embodiment

A second embodiment of the present invention is now described. This description centers principally on the points of difference with respect to the first embodiment, and points which are common to the first embodiment are either omitted or only described briefly here (this applies similarly to the third and fourth embodiments below).

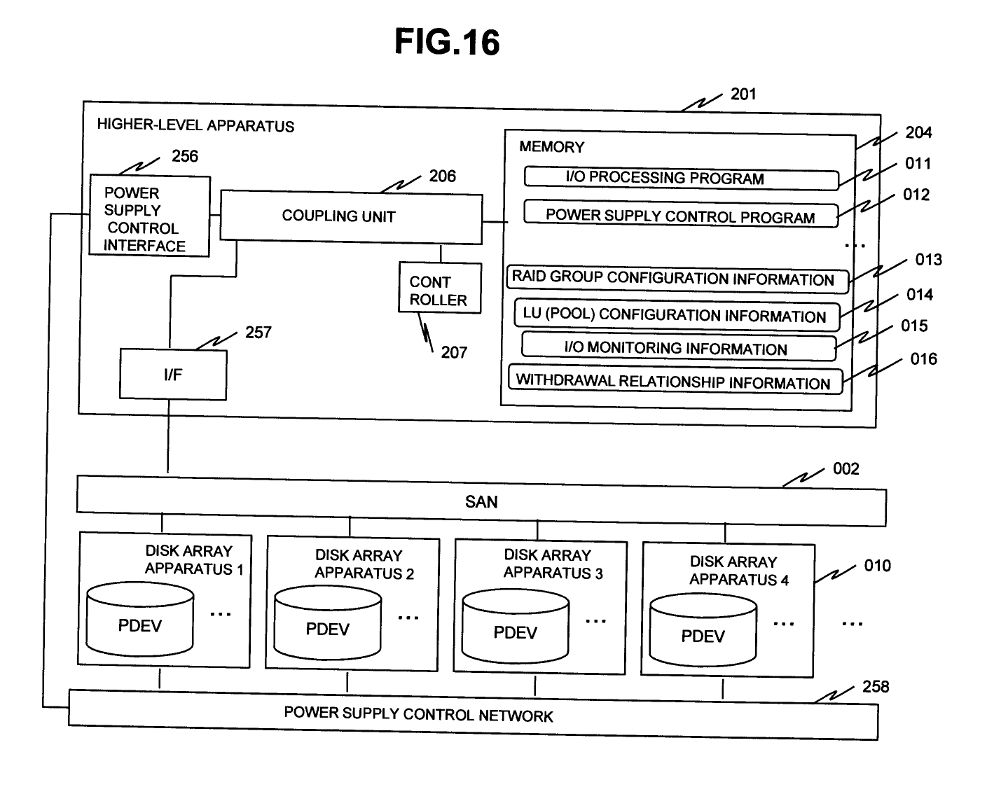

FIG. 16 shows a computer system to which the storage system relating to the second embodiment of the present invention is applied.

The SAN 002 is coupled to a plurality of disk array apparatuses 210 and one or more higher-level apparatus 101.

Furthermore, there is a power supply control network 258 which is a separate network from the SAN 002. The power supply control network 258 is a LAN (Local Area Network), for instance. Commands for controlling the power supply flow through this network 258.

In the present embodiment, transition to a power saving state and cancel of a power saving state are carried out in units of one disk array apparatus, rather than units of one RAID group. The power supply control for this purpose is performed by the high-level apparatus 204.

The higher-level apparatus 201 comprises a power supply control interface 256, a controller (for example a microprocessor) 207, an interface (for example, a host bus adapter) 257, a memory 204, and a coupling unit 206. The power supply control I/F 256 is an interface device, for example, an NIC (Network Interface Card), which is linked to the power supply control network 058. The I/F 257 is an interface device, for example, an HBA (Host Bus Adapter), which is linked to the SAN 002. The coupling unit 206 is, for example, a switch or bus for data transfer. The coupling unit 206 is coupled to the elements 256, 207, 257 and 204 which were described above. The communications between these elements are performed via the coupling unit 206. The memory 204 stores the I/O processing program 011, power supply control program 012, RAID group configuration information 013, LU (pool) configuration information 014, I/O monitoring information 015 and withdrawal relationship information 016 which were described in the first embodiment. The controller 207 is a microprocessor, for example, which executes the programs 011 and 012 contained in the memory 204.

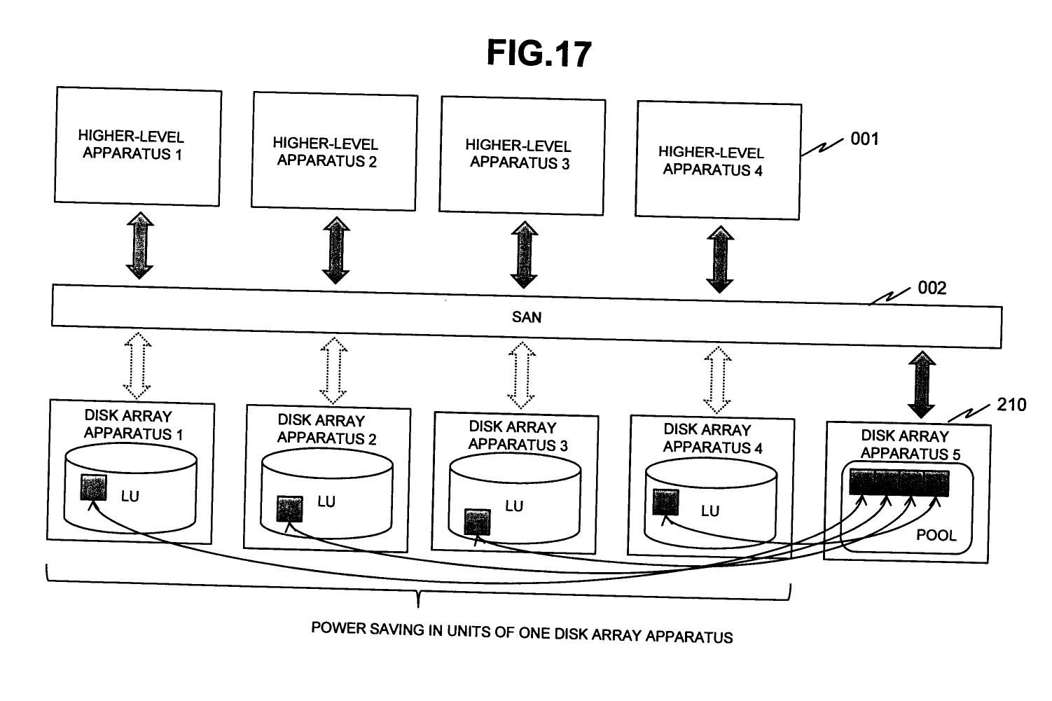

As shown in FIG. 17, in the present embodiment, power saving is carried out in units of disk array apparatuses. Therefore, for example, the withdrawal source area 038 and the withdrawal destination area 039 included in the withdrawal relationship information 016 may have the ID of a disk array apparatus 210, instead of a RAID_G_ID. Furthermore, at least one of the plurality of disk array apparatuses 210 is a disk array apparatus 210 providing a pool 018 (hereinafter called a pool array apparatus). The total capacity of the plurality of LUs 019 provided by the disk array apparatus 210 (hereinafter called LU array apparatus) providing the LUs 019 is greater than the total capacity of the pool 018.

In the present embodiment, the following processes are carried out.
An LU array apparatus having a time band of narrow I/O range is set as an LU array apparatus that is a spin down object.
The higher-level apparatus 201 specifies the withdrawal source area from the LU array apparatus that is a spin down object.
The higher-level apparatus 201 withdraws data element from the specified withdrawal source area to the pool area of the pool 018 provided by the pool array apparatus. The higher-level apparatus 201 adds information representing the correspondence between the withdrawal source area and the withdrawal destination area, to the withdrawal relationship information 016.
An LU array apparatus that is a spin down object is set to a power saving state by the higher-level apparatus 201, in the time band during which the I/O range of the LU array apparatus is narrower than the prescribed threshold value. More specifically, the power supply control program 012 executed by the higher-level apparatus 201 sends a power supply control command which instructs a transfer to power saving, to the LU array apparatus that is the spin down object, via the power supply control I/F 256. This power supply control command is sent to the destination LU array apparatus via the power supply control network 258. The LU array apparatus having received this power supply control command is set to a power saving state in response to this command. For example, in the LU array apparatus, all of the RAID groups providing the LUs 019 are set to a power saving state.
If there is a pool area corresponding to the logical area of the I/O destination, then as shown in FIG. 17, the higher-level apparatus 201 sends an I/O command specifying this pool area, to the pool array apparatus. By this means, I/O is carried out without canceling the power saving state of the LU array apparatus which provides the logical area of the I/O destination. It is also possible for I/O commands to be sent to the pool array apparatus only when the LU array apparatus providing the logical area of the I/O destination is in a power saving state.

### Third Embodiment

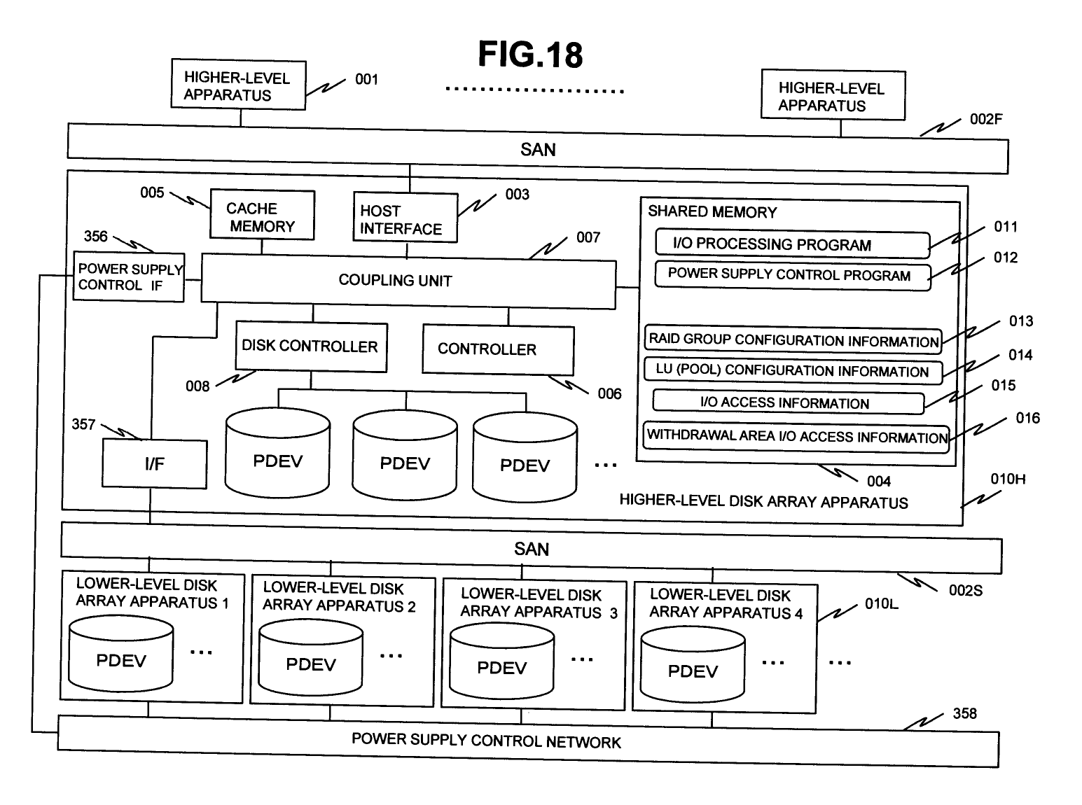

FIG. 18 shows a computer system having a group of disk array apparatuses which employs the storage system relating to a third embodiment of the present invention.

One or more higher-level apparatus 101 and a higher-level disk array apparatus 010H are coupled to the first SAN 002F.

A higher-level disk array apparatus 010H and a plurality of lower-level disk array apparatuses 010L are coupled to the second SAN 002S.

There is a power supply control network 358 which is a separate network from the SAN. The power supply control network 358 is a LAN (Local Area Network), for instance. Commands for controlling the power supply flow through this network 358.

In the present embodiment, transition to a power saving state and cancel of a power saving state are carried out in units of one lower-level disk array apparatus, rather than units of one RAID group. The power supply control for this is performed by the higher-level disk array apparatus 010H.

The controller 006 of the higher-level disk array apparatus 010H provides a virtual LU to the higher-level apparatus 001. The LU 019 corresponding to the virtual LU is located in any one of the lower-level disk array apparatuses 010L. Therefore, if an I/O operation to/from a particular virtual area occurs, then the higher-level disk array apparatus 010H sends an I/O command specifying the logical area corresponding to that virtual area, to the lower-level disk array apparatus 010L including that logical area. The higher-level disk array apparatus 010H may also have a NAS function. In other words, the higher-level disk array apparatus 010H may receive a file-level I/O command from a higher-level apparatus 001 and send a block-level I/O command to a lower-level disk array apparatus 010L.

The higher-level disk array apparatus 010H has a power supply control I/F 356 and an I/F 357, apart from the elements included in the disk array apparatus 010 shown in FIG. 1. The power supply control I/F 356 is an interface device, for example, an NIC (Network Interface Card), which is linked to the power supply control network 358. The I/F 357 is an interface device, for example, an HBA (Host Bus Adapter), which is linked to the second SAN 002S.

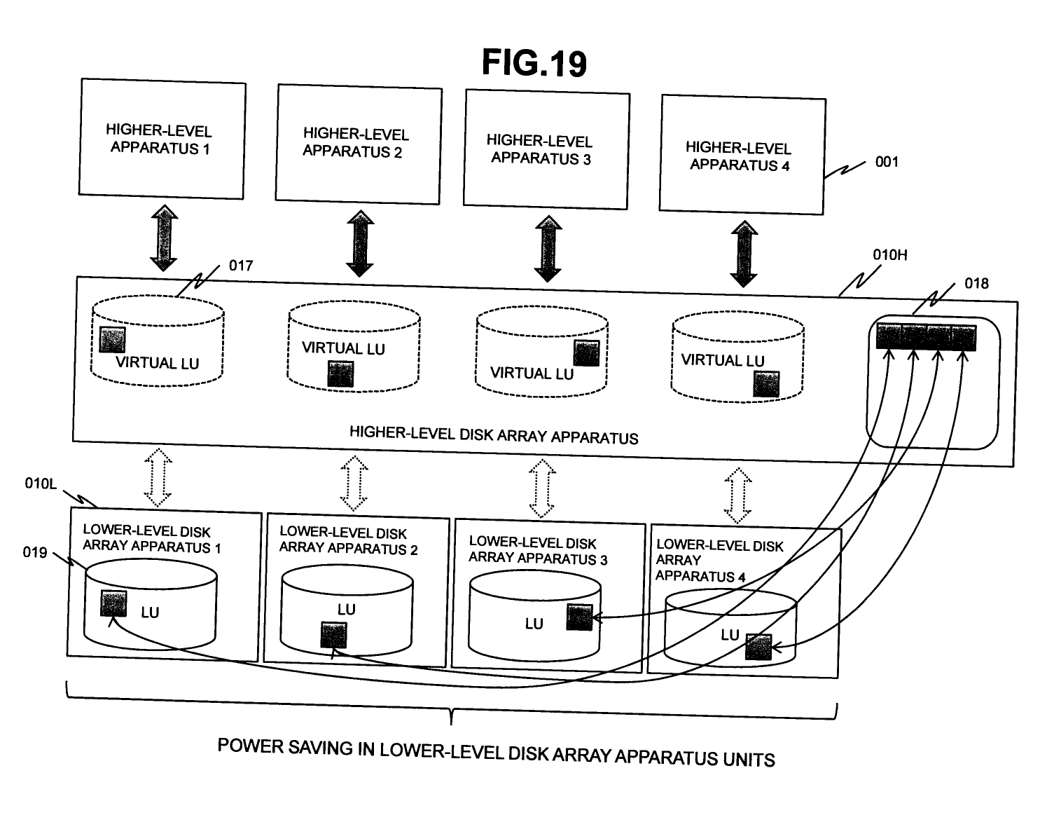

As shown in FIG. 19, in the present embodiment, power saving is carried out in units of lower-level disk array apparatuses. Therefore, for example, the withdrawal source area 038 and the withdrawal destination area 039 included in the withdrawal relationship information 016 may have the ID of a lower-level disk array apparatus 010L, instead of a RAID_G_ID. Furthermore, at least one of the plurality of lower-level disk array apparatuses 010L is a lower-level disk array apparatus 010H which provides a pool 018 (hereinafter called a pool lower-level array apparatus). The total capacity of the plurality of LUs 019 provided by the lower-level disk array apparatus 010H (hereinafter called LU lower-level array apparatus) providing the LUs 019 is greater than the total capacity of the pool 018.

In the present embodiment, the following processes are carried out.
An LU lower-level array apparatus having a time band of narrow I/O range is set as an LU lower-level array apparatus that is a spin down object.
The higher-level disk array apparatus 010H specifies the withdrawal source area from the LU lower-level array apparatus that is a spin down object.
The higher-level disk array apparatus 010H withdraws data element from the specified withdrawal source area to the pool area of the pool 018 provided by the pool lower-level array apparatus. The higher-level disk array apparatus 010H adds information representing the correspondence between the withdrawal source area and the withdrawal destination area, to the withdrawal relationship information 016.
An LU lower-level array apparatus that is a spin down object is set to a power saving state by the higher-level disk array apparatus 010H, during the time band where the I/O range of the LU lower-level array apparatus is narrower than the prescribed threshold value. More specifically, the power supply control program 012 executed by the higher-level disk array apparatus 010H sends a power supply control command which instructs a transfer to power saving, to the LU lower-level array apparatus that is the spin down object, via the power supply control I/F 356. This power supply control command is sent to the destination LU array apparatus via the power supply control network 358. The LU lower-level array apparatus having received this power supply control command is set to a power saving state in response to this command. For example, in the LU lower-level array apparatus, all of the RAID groups providing the LUs 019 are set to a power saving state.
If there is a pool area corresponding to the I/O destination logical area specified by the I/O command from the higher-level apparatus 001 (the logical area corresponding to the virtual area specified by the I/O command from the higher-level apparatus), then the higher-level disk array apparatus 010H sends an I/O command specifying the pool area, to the pool lower-level array apparatus, as shown in FIG. 19. By this means, I/O is carried out without canceling the power saving state of the LU lower-level array apparatus which provides the logical area of the I/O destination. It is also possible for I/O commands to be sent to the pool lower-level array apparatus only when the LU lower-level array apparatus providing the logical area of the I/O destination is in a power saving state.

### Fourth Embodiment

In the fourth embodiment of the present invention, a RAID group that is to be the object of spin down is specified automatically.

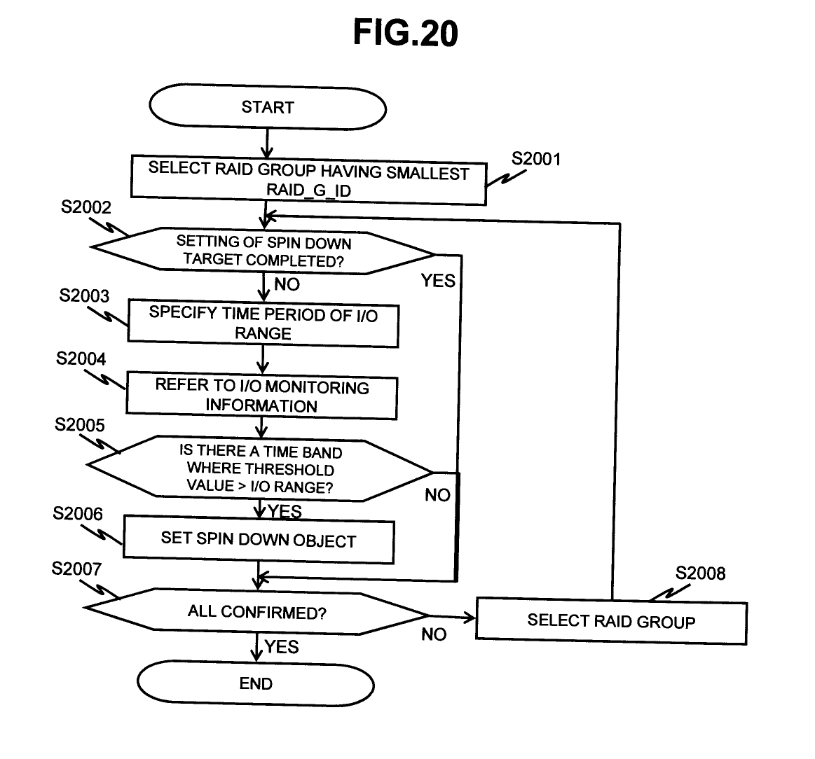

FIG. 20 is a flowchart of spin down object specification processing.

The spin down object specification processing is carried out before the start of the spin down processing in FIG. 9. The spin down object specification processing is started at a designated timing or at a timing indicated by the user. The spin down object specification processing is carried out either at regular or irregular intervals (for example, once per day or once per month).

The power supply control program 012 selects the RAID group having the smallest RAID_G_ID (S2001).

The program 012 judges whether or not the RAID group selected at S2001 (or S2008 below) is a RAID group that has already been set as a spin down object (S2002).

If the judgment result in S2002 is negative, then the program 012 specifies the time period during which the I/O range is to be considered (S2003). This time period may be, for example, the same as the time period based on the withdrawal source area specification policy selected by the user, or may be a time period indicated separately by the user.

The program 012 refers to the portion corresponding to the time period specified in S2003, of the I/O monitoring information 015 corresponding to the RAID group selected in S2001 (or S2008) (S2004).

The program 012 judges whether or not there is a time band during which the I/O range is less than the prescribed threshold value (S2005).

If the judgment result of S2005 is affirmative, the program 012 specifies that the RAID group selected at S2001 (or S2008) is to be set as a spin down object in the time band during which the I/O range is less than the prescribed threshold value (S2006).

If the judgment in S2002 has not yet been carried out in respect of at least one RAID group, then the program 012 selects an unselected RAID group (S2008). On the other hand, if the judgment in S2002 has been carried out in respect of all of the RAID groups, then the program 012 terminates the spin down object specification processing.

The specification processing shown in FIG. 20 can employ at least one of the second or the third embodiment, instead of or in addition to the first embodiment. In this case, the spin down object is a disk array apparatus 210 or lower-level disk array apparatus 010L, instead of the RAID group.

In the foregoing, several embodiments of the present invention were described, but the present invention is not limited to these embodiments and may of course be modified in various ways without departing from the essence of the invention. For example, the storage system according to the present invention may be employed in a storage system in the field of NAS. Furthermore, for example, the RAID group (or disk array apparatus) that is a spin down object may be specified on the basis of the I/O frequency, instead of or in addition to the I/O range. For example, a RAID group having an I/O frequency lower than a prescribed threshold value may be specified as a RAID group that is to be a spin down object. Furthermore, for example, “spin down object” may be understood abstractly as “power saving object”.

What is claimed is:

1. A storage system, comprising:
a plurality of physical storage device groups; and
a controller coupled to the plurality of physical storage device groups;
wherein each of the physical storage device groups is formed by one or more physical storage devices;
the plurality of physical storage device groups include first and second physical storage device groups;
the first physical storage device group stores a data element stored in a logical area of the physical storage device and is formed by one or more first physical storage devices which can be set to a power saving state during a first time band;
the second physical storage device group stores a data element stored in a pool area of a pool formed by a plurality of pool areas and is formed by one or more second physical storage devices which are not set to a power saving state while at least one of first physical storage devices is in a power saving state;
one or more pool areas of the pool correspond to a portion of logical areas constituting the plurality of logical areas;
a frequency of I/O (Input/Output) in each logical area of the portion of logical areas is higher than an I/O frequency of any logical area other than the portion of logical areas constituting the plurality of logical areas;
during the first time band, the controller
(X1) judges whether or not a pool area corresponding to an I/O destination logical area in the event of an I/O operation is present in the pool;
(X2) cancels, when the judgment result in (X1) is negative and the first physical storage device group is in a power saving state, the power saving state of the first physical storage device group and carries out I/O of data element to/from the I/O destination logical area;
(X3) carries out, when the judgment result in (X1) is affirmative, I/O of data element to/from the pool area corresponding to the I/O destination logical area, without canceling the power saving state of the first physical storage device group; and
(X4) sets, after (X2), the first physical storage device group to a power saving state.

2. A storage system according to claim 1, wherein
the first physical storage device group is in a non-power saving state during a second time band which is a time band further in the past than the first time band,
the controller measures the frequency of I/O for each logical area, during the second time band, and
before the start of the first time band, the controller
(M1) identifies logical areas in which the I/O frequency during the second time band is higher than a prescribed I/O frequency, as the portion of logical areas;
(M2) copies data elements from the portion of logical areas identified in (M1) to the pool; and
(M3) sets, after (M2), the first physical storage device group to a power saving state.

3. A storage system according to claim 2, wherein
there are a plurality of first physical storage device groups forming the basis of the plurality of logical storage devices, and
the controller performs the following (M0) of:
(M0) identifying a first physical storage device group in which the I/O frequency during the second time band is equal to or lower than a prescribed threshold value, or a first physical storage device group in which the total volume of the logical areas, to which I/O is carried out with respect to the capacity of the first physical storage device group during the second time band, is a prescribed ratio or less, on the basis of the I/O frequency measured in respect of each logical area of each logical storage device; and wherein
the controller performs the (M1), (M2) and (M3) with respect to the first physical storage device group identified in the (M0).

4. A storage system according to claim 3, wherein
the controller manages update management information, which is information representing, for each pool area, the logical area corresponding to the pool area, and an indication of whether or not there is an update data element, which is a data element not present in this corresponding logical area,
the I/O is a write operation, and the controller stores in the corresponding pool area a data element that is a write object in the (X3), and updates the update management information to information representing that there is an update data element in that pool area,
the I/O is a write operation, and the controller stores in a free pool area a data element that is a write object in the (X2), and updates the update management information to information representing that there is an update data element in that pool area, and
the controller cancels the power saving state of the first physical storage device group forming the basis of the logical storage devices having logical areas corresponding to the pool area which stores an update data element with a frequency lower than a frequency of increasing update data element in the pool, and copies only an update data element, of the plurality of data elements stored in the pool, to a logical storage device having a storage area corresponding to the pool area storing this update data element.

5. A storage system according to claim 4, wherein
the I/O is a write operation and the controller judges whether or not there is a free pool area in the (X3), and when this judgment result is affirmative, writes the data element that is a write object to the free pool area, and
a frequency lower than the frequency of increasing the update data element in the pool signifies a case where the judgment result in the (X3) is negative.

6. A storage system according to claim 5, wherein
the I/O is a read operation and the controller judges whether or not there is a free pool area, in the (X2), and when this judgment result is affirmative, stores data element read from the read source logical area in the free pool area, and
a frequency lower than the frequency of increasing the update data element in the pool signifies a case where the judgment result in the (X2) is negative.

7. A storage system according to claim 1, wherein
the first physical storage device group is in a non-power saving state during a second time band which is a time band further in the past than the first time band,
there are a plurality of first physical storage device groups forming the basis of the plurality of logical storage devices,
the controller measures the frequency of I/O for each logical area, during the second time band, and
a first physical storage device group which can be set to a power saving state during the first time band, of the plurality of first physical storage device groups, is a first physical storage device group in which the I/O frequency during the second time band is equal to or lower than a prescribed threshold value, or a first physical storage device group in which the total capacity of the logical area, to which I/O has been carried out with respect to the capacity of the first physical storage device group during the second time band, is a prescribed ratio or less.

8. A storage system according to claim 1, wherein
the controller manages update management information, which is information representing, for each pool area, the logical area corresponding to the pool area, and an indication of whether or not there is an update data element, which is a data element that is not present in this corresponding logical area,
the I/O is a write operation, and the controller stores a data element that is a write object in the corresponding pool area in the (X3), and updates the update management information to information representing that there is an update data element in that pool area,
the I/O is a write operation, and the controller stores a data element that is a write object in the free pool area in the (X2), and updates the update management information to information representing that there is an update data element in that pool area, and
the controller cancels the power saving state of the first physical storage device group forming the basis of the logical storage devices having logical areas corresponding to the pool area which is storing an update data element, with a frequency lower than the frequency of increasing update data element in the pool, and copies only an update data element, of the plurality of data elements stored in the pool, to a logical storage device having a storage area corresponding to the pool area storing this update data element.

9. A storage system according to claim 8, wherein a frequency lower than the frequency of increasing the updated element in the pool signifies a case where the ratio of the total capacity of the free pool area with respect to the capacity of the pool is less than a prescribed ratio.

10. A storage system according to claim 1, wherein
the second physical storage devices are physical storage devices which store a group of data elements of a prescribed size with lower power consumption than the first physical storage devices, and
the group of data elements comprises one or more data elements.

11. A storage system according to claim 1, wherein the second physical storage devices are SSDs (Solid State Drives) or SATA (Serial ATA)-HDDs (Hard Disk Drives).

12. A storage system according to claim 7, wherein the second time band is a time period of the same duration as the first time band.

13. A power saving method for a storage system having a plurality of physical storage device groups,
each of the physical storage device groups being formed by one or more physical storage devices,
the plurality of physical storage device groups including first and second physical storage device groups,
the first physical storage device group being formed by one or more first physical storage devices, and storing a data element which is stored in a logical area of logical storage devices formed by a plurality of logical areas, and
the second physical storage device group being formed by one or more second physical storage devices, and storing a data element which is stored in a pool area of a pool formed by a plurality of pool areas,
the power saving method comprising:
(a) associating a portion of logical areas of the plurality of logical areas with one or more pool areas of the pool, with the frequency of I/O (Input/Output) in each logical area of the portion of logical areas being made higher than the I/O frequency in any logical area other than the portion of logical areas of the plurality of logical areas;
(b) setting the first physical storage device group to a power saving state during a first time band;
(c) judging whether or not a pool area corresponding to an I/O destination logical area is present in the pool;
(d) when a judgment result in the (c) is negative and the first physical storage devices are in a power saving state, canceling the power saving state of the first physical storage device group and carrying out I/O of data element to/from the I/O destination logical area;
(e) when a judgment result in the (d) is affirmative, carrying out I/O of data element to/from the pool area corresponding to the I/O destination logical area, without canceling the power saving state of the first physical storage device group; and
(f) after the (d), setting the first physical storage device group to a power saving state.

14. A controller for a storage system having a plurality of physical storage device groups, wherein
each of the physical storage device groups is formed by one or more physical storage devices;
the plurality of physical storage device groups include first and second physical storage device groups,
the first physical storage device group is formed by one or more first physical storage devices, and stores a data element which is stored in a logical area of logical storage devices formed by a plurality of logical areas,
the second physical storage device group is formed by one or more second physical storage devices, and stores a data element which is stored in a pool area of a pool formed by a plurality of pool areas,
the controller comprises:
an interface device coupled to the plurality of physical storage device groups; and
a control device coupled to the interface device, and
the control device performs:
(a) associating a portion of logical areas of the plurality of logical areas with one or more pool areas of the pool, with the frequency of I/O (Input/Output) in each logical area of the portion of logical areas being made higher than the I/O frequency in each of the logical areas other than the portion of logical areas of the plurality of logical areas;
(b) setting the first physical storage device group to a power saving state during a first time band;
(c) judging whether or not a pool area corresponding to an I/O destination logical area is present in the pool;
(d) when a judgment result in the (c) is negative and the first physical storage devices are in a power saving state, canceling the power saving state of the first physical storage device group and carrying out I/O of data element to/from the I/O destination logical area;
(e) when a judgment result in the (d) is affirmative, carrying out I/O of data element to/from the pool area corresponding to the I/O destination logical area, without canceling the power saving state of the first physical storage device group, and
(f) after the (d), setting the first physical storage device group to a power saving state.
